(19) United States
(12) Patent Application Publication
(10) Pub. No.: US 2021/0108626 A1
(43) Pub. Date: Apr. 15, 2021

(54) Gas and gas mixture collection and delivery apparatus

(71) Applicant: Lawrence Aldo Rabellino, Atascadero, CA (US)

(72) Inventor: Lawrence Aldo Rabellino, Atascadero, CA (US)

(21) Appl. No.: 17/067,762

(22) Filed: Oct. 12, 2020

Related U.S. Application Data
(60) Provisional application No. 62/913,173, filed on Oct. 10, 2019.

(51) Int. Cl. F04B 39/00; F15B 1/24

(52) U.S. Cl. CPC F04B 39/0005; F15B 1/24

(57) ABSTRACT

A system and method and apparatus includes a cylinder having corresponding end caps and wherein each end cap includes at least one corresponding gas port and a floating piston disposed within the cylinder, the floating piston including at least one seal, the at least one seal being operative to form a seal between the floating piston and an inner surface of the cylinder.

### CROSS REFERENCE TO RELATED APPLICATIONS

This application claims priority from U.S. Provisional Patent Application No. 62/913,173 filed on Oct. 10, 2019 and entitled “Gas and Gas Mixture Collection and Delivery Apparatus,” which is incorporated herein by reference in its entirety for all purposes.

### FIELD OF THE DISCLOSURE

The present disclosure relates generally to gas handling systems, and more particularly, to methods and systems for collecting and delivering gas and gas mixtures.

### SUMMARY

Broadly speaking, the present disclosure fills these needs by providing a system, method and apparatus for capturing gases and gas mixtures. It should be appreciated that the present disclosure can be implemented in numerous ways, including as a process, an apparatus, a system, or a device. Several inventive embodiments of the present disclosure are described below.

One implementation includes a system and method and apparatus including a cylinder having corresponding end caps and wherein each end cap includes at least one corresponding gas port and a floating piston disposed within the cylinder, the floating piston including at least one seal, the at least one seal being operative to form a seal between the floating piston and an inner surface of the cylinder

The at least one seal can include at least two seals and wherein the at least two seals are separated by an isolation volume disposed between the at least two seals. The floating piston can be capable of translating to either end of the cylinder, the floating piston capable of defining three distinct volumes including a process gas volume, an actuation gas volume, and the isolation volume disposed between the seals in the piston.

In at least one implementation, the floating piston can include a tube coupling the isolation volume to a facility external from the cylinder, wherein the facility can selectively supply at least one of a purge gas source and a vacuum source to the isolation volume. Selectively supplying at least one of a purge gas source and a vacuum source to the isolation volume can control contamination of the isolation volume. When a vacuum source is applied to the isolation volume, a loss of vacuum or a presence of gas in the isolation volume can identify a leak in at least one of the at least two seals.

In at least one implementation, the floating piston can include two sets of double seals and an isolation volume between each set of seals. The two double seal features are separated by an isolation volume, providing a total of three isolation volumes. The isolation volumes can be fluidly coupled together or alternatively, can be individually isolated. In at least one implementation a gas passage fluidly couples the three isolation volumes together to allow the isolation volumes to share a single gas or vacuum as may be desired for the corresponding operation. The cylinder can also include a port coupled to each of the isolation volumes. The center isolation volume port allows a source of either vacuum or purge gas, as may be desired, for either leak detection, dilution or purging.

In at least one implementation, a single cylinder can be used to collect and deliver gas in a batch process where collection and delivery would alternate.

In at least one implementation, multiple cylinders can be used in parallel. The multiple cylinder the system can collect and deliver gas at the same time, with one cylinder performing each process.

In at least one implementation, three parallel cylinders could be used. One cylinder for collection, one cylinder for delivery and one cylinder as standby to be ready for either collection or delivery, as needed by the application.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The present disclosure will be readily understood by the following detailed description in conjunction with the accompanying drawings.

FIGS. 1A-1C are simplified schematic diagrams of a system for capturing gases and gas mixtures for implementing embodiments of the present disclosure.

FIG. 2 is a simplified schematic diagram of a system for capturing gases and gas mixtures for implementing embodiments of the present disclosure.

FIG. 3 is a simplified schematic diagram of a system for capturing gases and gas mixtures for implementing embodiments of the present disclosure.

FIG. 4 is a simplified schematic diagram of a system for collecting and delivering gases and gas mixtures for implementing embodiments of the present disclosure.

### DETAILED DESCRIPTION

Several exemplary embodiments for systems, methods and apparatus for capturing gases and gas mixtures will now be described. It will be apparent to those skilled in the art that the present disclosure may be practiced without some or all of the specific details set forth herein.

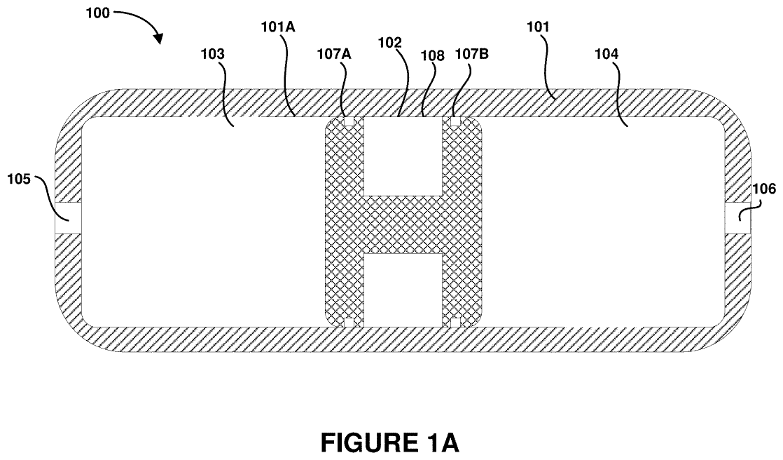

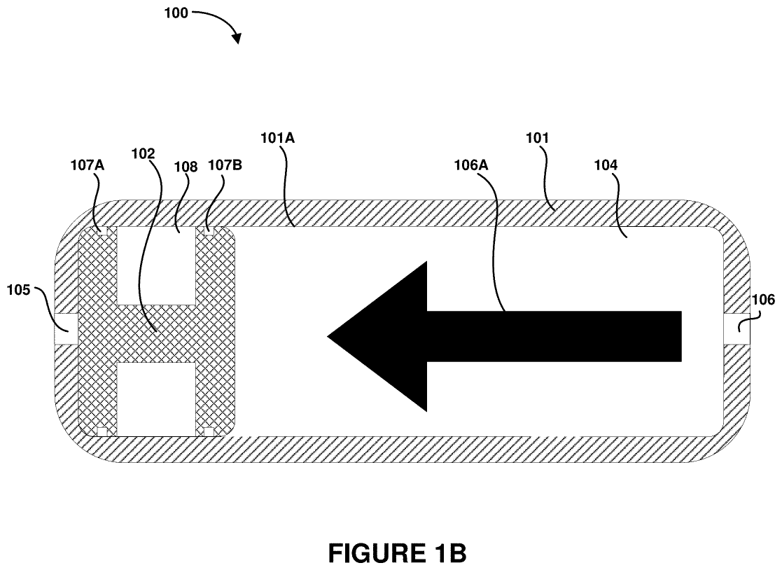

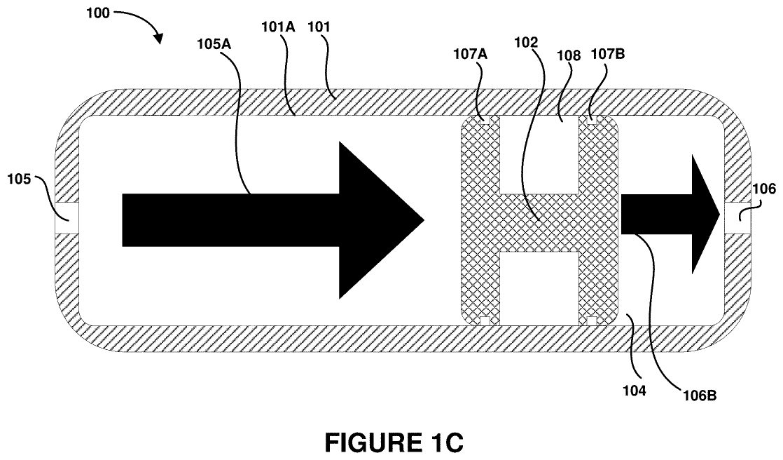

The purpose of this apparatus is to collect and deliver gas and gas mixtures. FIGS. 1A-1C are simplified schematic diagrams of a system 100 for capturing gases and gas mixtures for implementing embodiments of the present disclosure. The system 100 includes a cylinder 101 with a floating piston 102 inside, and gas connection ports 105, 106 on each end of the cylinder. The piston 102 is approximately centered in the cylinder 101, as shown. The floating piston also includes one or more seals 107A, 107B that form a substantially gas proof seal between the floating piston and an inner surface 101A of the cylinder.

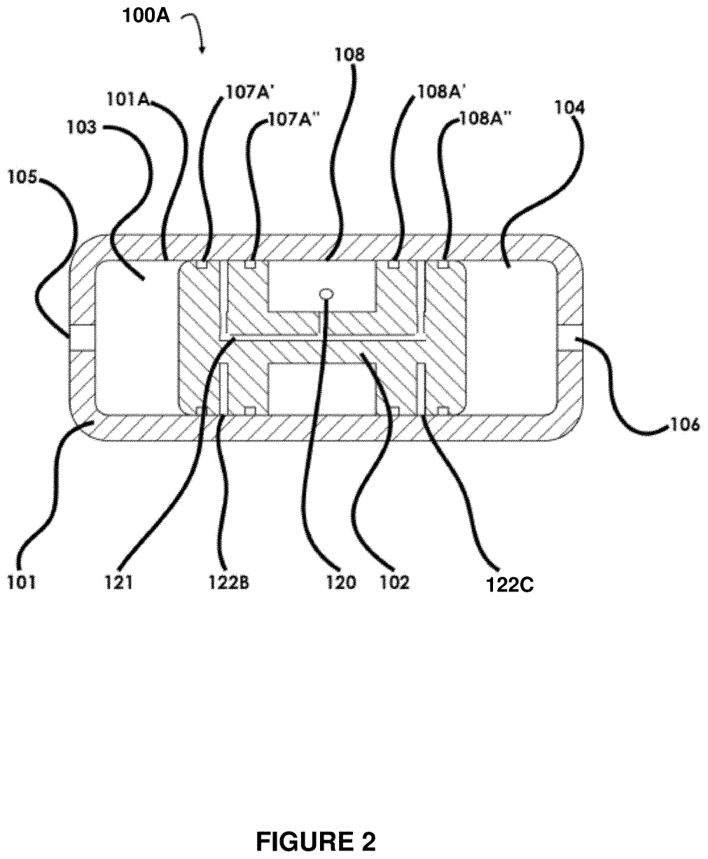

In another implementation, the floating piston 102 can also have only a single seal with sufficient piston skirt width to prevent binding. The double seal 107A, 10713 has a. secondary, optional purpose which provides an isolation volume 108 which can be either purged or evacuated to improve separation of the process gas from the actuation gas, as shown in FIG. 2.

The cylinder 101 includes a process gas volume 103 on the left side of the floating piston 102, as shown, and an actuation volume 104 on the right side of the floating piston, as shown. The process gas volume 103 includes a process gas port 105 for delivery of process gas to and/or from the process gas volume. The actuation volume 104 includes an actuation port 106 for delivery of an actuation gas pressure and/or an actuation vacuum to the actuation volume.

As shown in FIGS. 1A-C the system 100 has three operating modes: Collection, Standby and Delivery. FIG. 1A shows the floating piston 102 substantially centered in the cylinder 101. Selectively, applying actuation gas pressure 106A and actuation vacuum 106B through the actuation port 106, to the actuation volume 104 can cause the floating piston 102 to move to correspondingly increase or decrease the process gas volume 103 size, as may be desired. As shown in FIG. 1B, the actuation volume 104 is maximized by applying an actuation gas pressure 106A to the actuation volume 104. The actuation gas pressure 106A is greater than a process gas pressure 105A present in the process gas volume 103, causing the floating piston 102 to move left, as shown, and thereby reduce and/or minimize the process gas volume size so as to deliver process gas from the process gas volume and out the process gas port 105.

As shown in FIG. 1C, the actuation volume 104 is reduced or minimized by applying a lower pressure actuation gas pressure 106A′ or a vacuum 106B to the actuation volume 104. The lower pressure actuation gas pressure 106A′ and the vacuum 106B applied in this operating state is less than the process gas pressure 105A in the process gas volume 103, causing the floating piston 102 to move right, as shown and thereby reducing and/or eventually minimizing the activation gas volume size and maximizing the process gas volume size (with the piston fully drawn to the right, as shown) so as to draw in the maximum volume of process gas into the process gas volume.

FIG. 2 is a simplified schematic diagram of a system 100A for capturing gases and gas mixtures for implementing embodiments of the present disclosure. The system 100A includes the floating piston 102 which also includes a first double seal 107A′, 107A″ isolating the isolation volume 108 from the process gas volume 103. The floating piston 102 can also include a second double seal 107B′, 107B″ isolating the isolation volume 108 from the actuation gas volume 104. One or more isolation channels 122B, 122C can also be included. The isolation channel 122B can be utilized to monitor, purge or evacuate gas that manages to leak between the double seals 107A′, 107A″. Similarly, the isolation channel 122C can be utilized to monitor, purge or evacuate gas that manages to leak between the double seals 107B′, 107B″.

The isolating the isolation volume 108 can be evacuated or pressurized and combinations thereof, as may be desired for the present operational mode to provide shield gas function described above, or allow purging. The isolation volume port 120 is fluidly coupled to the isolation volume 108. The isolation volume port can be selectively and alternatively coupled to vacuum or gas sources external to the cylinder 101. The isolation volume 108 is a fixed size and therefore does not substantially affect the movement of the floating piston 102 within the cylinder 101.

In at least one implementation, the isolation volume 108 can include a gas shield. The gas shield can contain any suitable gas as may be compatible with the process and activation gases. A typical shield gas is a gas from the noble gas family of gases including helium, neon, argon, krypton, xenon and radon. The gas shield has a pressure higher than the pressures of either of the process gas volume and the activation gas volume. The shield gas applies pressure to the isolation volume between the two seals 107A, 107B to prevent process gas from the process gas volume and the activation gas from the activation gas volume from mixing inside the cylinder. Because the isolation volume filled by the shield gas is a constant volume, then the pressure of the shield gas does not restrict or assist the movement of the piston.

The isolation channel 122B can be selectively and alternatively coupled to vacuum or gas sources external to the cylinder 101. Similarly, the isolation channel 122C can be selectively and alternatively coupled to vacuum or gas sources external to the cylinder 101. In at least one implementation, the isolation channels 122B, 122C can be fluidly coupled to the isolation volume 108.

In at least one implementation, the length of the floating piston 102 and the isolation volume are selected such that when the floating piston is fully left within the cylinder 101, the isolation volume port 120 is not covered by the floating piston, thereby allowing the isolation volume 108 to be monitored, evacuated or purged during the delivery of the process gas.

In at least one implementation, the length of the floating piston 102 and the isolation volume are selected such that when the floating piston is fully right within the cylinder 101, the isolation volume port 120 is not covered by the floating piston, thereby allowing the isolation volume 108 to be monitored, evacuated or purged during the collection of the process gas.

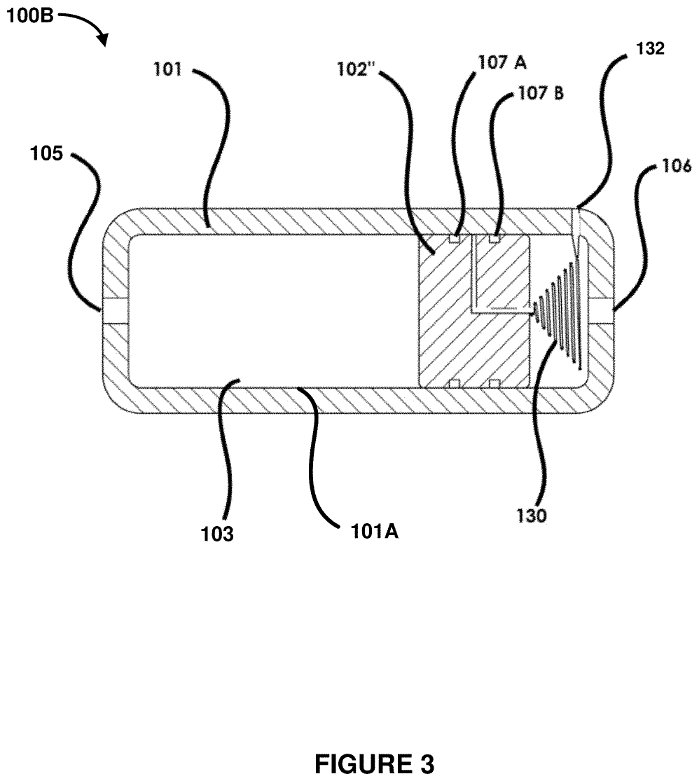

FIG. 3 is a simplified schematic diagram of a system 100B for capturing gases and gas mixtures for implementing embodiments of the present disclosure. The system 100A includes a tube 130 fluidly and flexibly coupling the isolation volume 108 to an isolation tube port 132. The isolation tube port 132 can be selectively coupled to either a purge supply or vacuum source that is external from the cylinder 101. In one implementation, the tube 130 coupled to the isolation volume 108 can be a tapered helical formed stainless-steel tube. In at least one implementation, the tapered, helically shaped stainless-steel tube 130 can be designed to nest substantially flat inside the cylinder 101 such that when the process gas volume 103 is maximized and the floating piston 102 is fully extended to the right side of the cylinder.

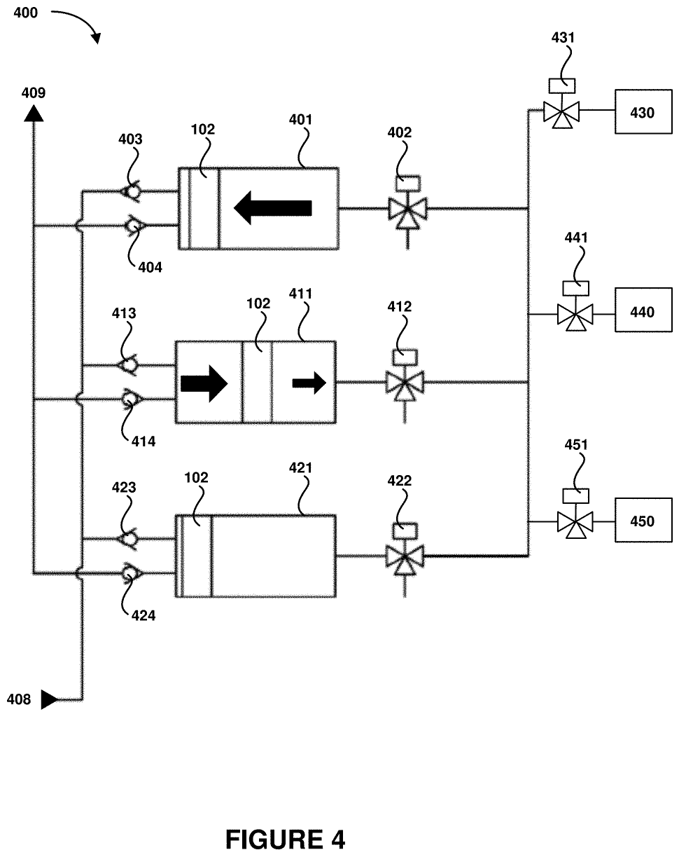

FIG. 4 is a simplified schematic diagram of a system 400 for collecting and delivering gases and gas mixtures for implementing embodiments of the present disclosure. The system includes three cylinder 401, 411 and 421 coupled in parallel. It should be understood that the system 400 can include a single cylinder, two cylinders or more than three cylinders. Three cylinders are shown for discussion purposes only.

In operation, cylinder 401 is shown in the deliverer mode where the process gas is forced out of the cylinder and through outlet valve 404 to the system outlet 409. Inlet valve 403 allows process gas into the finder 401, from the process gas inlet 408, during the collection mode. Inlet and outlet valves 403, 404 can be actuated valves or check valves in varying implementations. Actuation valve 402 controls the gas pressure in the activation volume 104 of cylinder 401. Actuation valve 402 can selectively apply activation gas pressure from an activation gas source 430, vent activation gas pressure from the activation volume 104 through an atmospheric pressure vent 440 and/or apply a vacuum from a vacuum source 450. Each of the activation gas source 430, the vent 440 and the vacuum source 450 include respective isolation. valves 431, 441, 451. The process gas can exit simply due to its own residual pressure is higher than a system outlet pressure present at the system outlet 409, without any movement of the floating piston. Alternatively, the process gas can exit out the process gas volume, through the process gas port, due to an actuation gas pressure applied to the actuation volume side of the floating piston causing the piston to move left, as shown in FIG. 1B. Using controlled pressure on the actuation side of the floating piston can allow a constant delivery pressure without requiring a pressure regulator in the process gas stream.

Cylinder 411 is shown in the collection mode. The collection mode can begin with the floating piston in any position from zero to one hundred percent process gas volume. FIG. 1B, above, shows the floating piston in a substantially zero percent process gas volume. Starting base pressure in the collection mode can be anything from 0 Torr to maximum rated pressure for the cylinder.

In the collection mode, process gas enters the process gas port though the inlet valve 414 and fills the process gas volume until the desired amount of process gas for the application has been achieved. In one implementation of collection mode operation, the actuation volume is sufficiently pressurized by applying an actuation gas pressure to the actuation volume to force the floating piston to the left, as shown in FIG. 1B to minimize the size of the free process gas volume. Then, an actuation vacuum can be applied to the actuation volume, which moves the floating piston toward the right, as shown in FIG. 1C, until the pressure is balanced on each side of the floating piston (with consideration for the seal resistance of the floating piston). The actuation vacuum can continue to be applied to effectively scavenge the process gas to be collected in the free process gas volume.

An alternate collection mode starts with the piston again at the 0% free volume position (floating piston fully left, as shown in FIG. 1B), but the process gas is applied to the cylinder 414 under pressure, forcing the floating piston to the right, as shown in FIG. 1C, into the actuation volume, as process gas enters the free process gas volume. Floating piston position and residual pressure are application specific.

Cylinder 421 is shown in a standby operating mode, there is no activity. The apparatus is sitting idle waiting for the next operating mode to begin. It is possible to heat, or cool the cylinder to support the application during the standby operating mode. Heating or cooling the process gas in standby operating mode can allow density changes as desired, or even allow the process gas to condense (phase change). Note that the apparatus can have as many “collection mode” cycles in sequence or “delivery mode” cycles in sequence as required for the application. There is no restriction on the order in which the modes can be applied.

It should be noted that cylinders 401, 41 1, 421 can cycle through each one of the standby, collection and delivery operational modes. Having multiple cylinders working simultaneously allows substantially continuous operation of each of the operational modes. Each of the valves 402, 403, 404, 412, 413, 414, 422, 423, 424, 431, 441, 451 can be manually or automatically (electromechanically, pneumatically, etc.) controlled and combinations thereof.

Materials of construction can include stainless steel and/or aluminum and/or stainless-steel alloys, and/or aluminum alloys and combinations thereof and any other suitable materials for the cylinder and piston. The tapered helical stainless-steel tube can be formed from PTFE or other suitable polymers, stainless steel and stainless-steel alloys. The seal materials can include Kel-F, PTFE and the existing variety of suitable polymers offered by Parker Hannifin and any other suitable materials.

Other materials of construction could include the entire polymer family (plastics, Teflon, etc), copper and copper alloys, the superalloy family (Inconel, Hastelloy, etc), and the carbon steel family. Plating could be employed, such as copper, nickel, chrome and titanium nitride. Coatings could be employed, such as wet paint and powder coating. Surface finishes and tolerances for the piston and cylinder would be defined by the seal manufacturer.

Although the foregoing disclosure has been described in some detail for purposes of clarity of understanding, it will be apparent that certain changes and modifications may be practiced within the scope of the appended claims. Accordingly, the present embodiments are to be considered as illustrative and not restrictive, and the disclosure is not to be limited to the details given herein, but may be modified within the scope and equivalents of the appended claims.

What is claimed is:

1. An apparatus comprising:
a cylinder having corresponding end caps and wherein each end cap includes at least one corresponding gas port; and
a floating piston disposed within the cylinder, the floating piston including at least one seal, the at least one seal being operative to form a seal between the floating piston and an inner surface of the cylinder.

2. The apparatus of claim 1, wherein the at least one seal includes at least two seals and wherein the at least two seals are separated by an isolation volume disposed between the at least two seals.

3. The apparatus of claim 2, wherein the floating piston is capable of translating to either end of the cylinder, the floating piston capable of defining three distinct volumes including a process gas volume, an actuation gas volume, and the isolation volume disposed between the seals in the piston.

4. The apparatus of claim 2, wherein the floating piston includes a tube coupling the isolation volume to a facility external from the cylinder, wherein the facility can selectively supply at least one of a purge gas source and a vacuum source to the isolation volume.

5. The apparatus of claim 4, wherein selectively supplying at least one of a purge gas source and a vacuum source to the isolation volume controls contamination of the isolation volume.

6. The apparatus of claim 5, wherein when a vacuum source is applied to the isolation volume and a loss of vacuum or a presence of gas in the isolation volume identifies a leak in at least one of the at least two seals.
